(19) United States
(12) Patent Application Publication
(10) Pub. No.: US 2023/0344876 A1
(43) Pub. Date: Oct. 26, 2023

(54) IMS CALL ESTABLISHING METHOD AND ELECTRONIC DEVICE AND USER EQUIPMENT THEREOF

(71) Applicant: MEDIATEK INC., Hsinchu City (TW)

(72) Inventors: Kai-Wen LIU, Hsinchu City (TW); Po-Chun LEE, Hsinchu City (TW); Yuan-Ting HUANG, Hsinchu City (TW); Yu-Hua HUANG, Hsinchu City (TW)

(21) Appl. No.: 17/724,774

(22) Filed: Apr. 20, 2022

(51) Int. Cl. H04L 65/1016; H04W 8/20; H04L 65/1069; H04W 76/10

(52) U.S. Cl. CPC H04L 65/1016; H04W 8/20; H04L 65/1069; H04W 76/10

(57) ABSTRACT

An IP Multimedia Subsystem (IMS) call establishing method is provided. The IMS call establishing method is applied to an electronic device which supports IMS service. The IMS call establishing method includes the steps of establishing a network connection between the electronic device and a client device; when the client device dials an IMS call, the electronic device obtains call information of the IMS call through the network connection; and the electronic device establishes the IMS call based on the call information of the IMS call.

### BACKGROUND OF THE INVENTION

### Field of the Invention

The invention generally relates to an IP Multimedia Subsystem (IMS) call establishing technology, and more particularly, to an IMS call establishing technology in which a user equipment (UE) establishes an IMS call through an electronic device which supports IMS service.

### Description of the Related Art

GSM/GPRS/EDGE technology is also called 2G cellular technology, WCDMA/CDMA-2000/TD-SCDMA technology is also called 3G cellular technology, and LTE/LTE-A/TD-LTE technology is also called 4G cellular technology. These cellular technologies have been adopted for use in various telecommunication standards to provide a common protocol that enables different wireless devices to communicate on a municipal, national, regional, and even global level. An example of an emerging telecommunication standard is the 5G New Radio (NR). The 5G NR is a set of enhancements to the LTE mobile standard promulgated by the Third Generation Partnership Project (3GPP). It is designed to better support mobile broadband Internet access by improving spectral efficiency, reducing costs, and improving services.

In current communication technologies, the user equipment (UE) may use an IP Multimedia Subsystem (IMS) service to dial an IMS call (e.g. a voice over NR (VoNR) call for 5G network or a voice over LTE (VoLTE) call for 4G network). However, when the UE does not support IMS service, the UE will not be able to dial an IMS call. If the user of the UE which does not support IMS service wants to dial an IMS call through the UE, the user needs to spend extra money to enable the IMS service of the UE.

### BRIEF SUMMARY OF THE INVENTION

A an IP Multimedia Subsystem (IMS) call establishing method, an electronic device and user equipment are provided to overcome the problems mentioned above.

An embodiment of the invention provides an IP Multimedia Subsystem (IMS) call establishing method. The IMS call establishing method is applied to an electronic device which supports IMS service. The IMS call establishing method comprises the steps of establishing a network connection between the electronic device and a client device; when the client device dials an IMS call, the electronic device obtains call information of the IMS call through the network connection; and the electronic device establishes the IMS call based on the call information of the IMS call.

An embodiment of the invention provides an electronic device for establishing IP Multimedia Subsystem (IMS) calls. The electronic device comprises a Subscriber Identity Module (SIM) card, a communication circuit and a processor. The first SIM card supports the IMS service. The communication circuit is configured to establish a network connection between the electronic device and a client device. When the client device dials an IMS call, the communication circuit obtains call information of the IMS call from the client device through the network connection. The processor is coupled to the communication circuit. The processor establishes the IMS call based on the call information of the IMS call.

An embodiment of the invention provides a user equipment (UE). The UE comprises a communication circuit and a processor. The communication circuit is configured to establish a network connection between an electronic device which supports IP Multimedia Subsystem (IMS) service and the UE. When the UE dials an IMS call, the communication circuit transmits call information of the IMS call to the electronic device through the network connection. The processor is coupled to the communication circuit. After the IMS call is established by the electronic device, the processor processes the IMS call.

Other aspects and features of the invention will become apparent to those with ordinary skill in the art upon review of the following descriptions of specific embodiments of the IMS call establishing method, the electronic device and the user equipment.

### BRIEF DESCRIPTION OF THE DRAWINGS

The invention will become more fully understood by referring to the following detailed description with reference to the accompanying drawings, wherein:

FIG. 1 is a block diagram of an IP Multimedia Subsystem (IMS) call establishing system 100 according to an embodiment of the invention.

FIG. 2 is a flow chart illustrating a IMS call establishing method according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

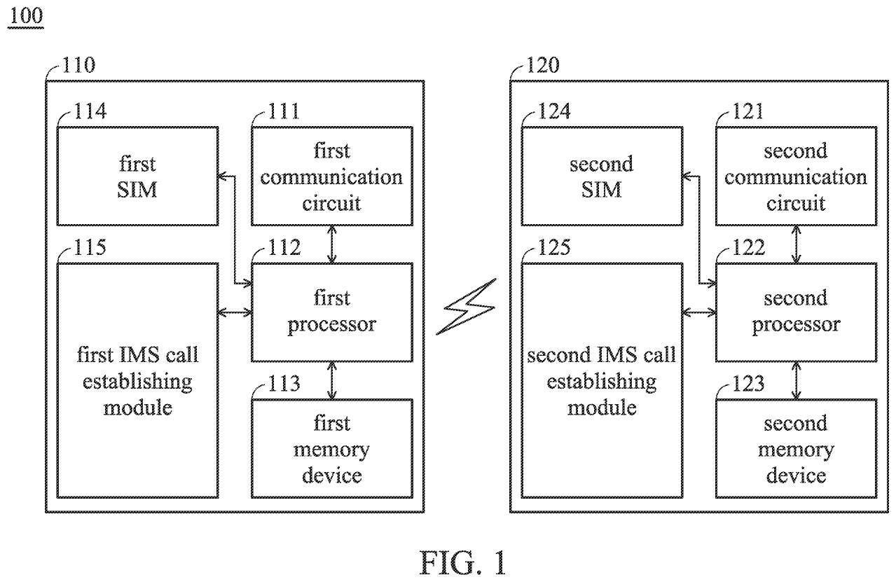

FIG. 1 is a block diagram of an IP Multimedia Subsystem (IMS) call establishing system 100 according to an embodiment of the invention. As shown in FIG. 1, the IMS call establishing system 100 includes an electronic device 110 and a client device 120. It should be noted that in order to clarify the concept of the invention, FIG. 1 presents a simplified block diagram in which only the elements relevant to the invention are shown. However, the invention should not be limited to what is shown in FIG. 1. The IMS call establishing system 100 may also comprise more client devices.

In the embodiments of the invention, the electronic device 110 may provide the internet connection to the client devices (e.g. the client device 120). The electronic device 110 may be a router or a Customer Premise Equipment (CPE), but the invention should not be limited thereto. In addition, in the embodiments of the invention, the electronic device 110 may support IP Multimedia Subsystem (IMS) service.

In the embodiments of the invention, the client device 120 may be a user equipment (UE), e.g. a cell phone, a tablet computer, a notebook, but the invention should not be limited thereto.

As shown in FIG. 1, the electronic device 110 may include a first communication circuit 111, a first processor 112, a first memory device 113, a first Subscriber Identity Module (SIM) card 114 and a first IMS call establishing module 115. It should be noted that in order to clarify the concept of the invention, FIG. 1 presents a simplified block diagram in which only the elements relevant to the invention are shown. However, the electronic device 110 should not be limited to what is shown in FIG. 1.

In the embodiments of the invention, the first communication circuit 111 may comprise different network interfaces, e.g. wire network interface or wireless network interface. The wire network interface may comprise the Ethernet interface, but the invention should not be limited thereto. The wireless network interface may comprise Wi-Fi interface or Bluetooth interface, but the invention should not be limited thereto. The electronic device 110 may be connected to the client device 120 through the first communication circuit 111. In addition, in the embodiments of the invention, the first communication circuit 111 may further comprise at least one radio frequency (RF) module. The RF module may comprise a plurality antennas and the RF module may be allocated to the first SIM card 114. In an embodiment of the invention, the first SIM card 114 may support IMS service, i.e. the electronic device 110 has IMS service capability.

In the embodiments of the invention, the RF module may comprise a RF signal processing circuit and a baseband signal processing circuit. The RF signal processing circuit may receive RF signals via the antenna and process the received RF signals to convert the received RF signals to baseband signals to be processed by the baseband signal processing circuit, or receive baseband signals from the baseband signal processing circuit and convert the received baseband signals to RF signals to be transmitted to a peer communications apparatus. The RF signal processing circuit may comprise a plurality of hardware elements to perform radio frequency conversion. For example, the RF signal processing circuit may comprise a power amplifier, a mixer, analog-to-digital converter (ADC)/digital-to-analog converter (DAC), etc. The baseband signal processing circuit may further process the baseband signals to obtain information or data transmitted by the peer communications apparatus. The baseband signal processing circuit may also comprise a plurality of hardware elements to perform baseband signal processing.

In the embodiments of the invention, the first processor 112 may control the operations of the first communication circuit 111, the first memory device 113 and the first IMS call establishing module 115. According to an embodiment of the invention, the first processor 112 may also be arranged to execute the program codes of the software modules. The program codes accompanied by specific data in a data structure may also be referred to as a processor logic unit or a stack instance when being executed. Therefore, the first processor 112 may be regarded as being comprised of a plurality of processor logic units, each for executing one or more specific functions or tasks of the corresponding software modules.

In the embodiments of the invention, the first memory device 113 may store the software and firmware program codes, system data, user data, etc. of the electronic device 110. The first memory device 113 may be a volatile memory such as a Random Access Memory (RAM); a non-volatile memory such as a flash memory or Read-Only Memory (ROM); a hard disk; or a combination thereof.

In the embodiments of the invention, the first IMS call establishing module 115 can be implemented and configured by hardware, firmware, software, and any combination thereof. The first IMS call establishing module 115, when executed by the first processor 112 (e.g., via executing program codes stores in first memory device 113), allow the electronic device 110 to perform embodiments of the present invention.

Furthermore, shown in FIG. 1, the client device 120 may include a second communication circuit 121, a second processor 122, a second memory device 123, a second SIM card 124 and a second IMS call establishing module 125. It should be noted that in order to clarify the concept of the invention, FIG. 1 presents a simplified block diagram in which only the elements relevant to the invention are shown. However, the client device 120 should not be limited to what is shown in FIG. 1.

In the embodiments of the invention, the second communication circuit 121 may comprise different wireless network interfaces. The wireless network interface may comprise Wi-Fi interface or Bluetooth interface, but the invention should not be limited thereto. The client device 120 may be connected to the electronic device 110 through the second communication circuit 121. In addition, in the embodiments of the invention, the second communication circuit 121 may further comprise at least one radio frequency (RF) module. The RF module may comprise a plurality antennas and the RF module may be allocated to the second SIM card 124. In an embodiment of the invention, the second SIM card 124 may support IMS service. In another embodiment of the invention, the second SIM card 124 may not support IMS service. In the embodiments of the invention, the RF module may comprise a RF signal processing circuit and a baseband signal processing circuit. The RF signal processing circuit and the baseband signal processing circuit of the client device 120 are similar to the RF signal processing circuit and the baseband signal processing circuit of the electronic device 110. Therefore, no more details are illustrated again.

In the embodiments of the invention, the second processor 122 may control the operations of the second communication circuit 121, the second memory device 123 and the second IMS call establishing module 125. According to an embodiment of the invention, the second processor 122 may also be arranged to execute the program codes of the software modules. The program codes accompanied by specific data in a data structure may also be referred to as a processor logic unit or a stack instance when being executed. Therefore, the second processor 122 may be regarded as being comprised of a plurality of processor logic units, each for executing one or more specific functions or tasks of the corresponding software modules.

In the embodiments of the invention, the second memory device 123 may store the software and firmware program codes, system data, user data, etc. of the client device 120. The memory device 123 may be a volatile memory such as a Random Access Memory (RAM); a non-volatile memory such as a flash memory or Read-Only Memory (ROM); a hard disk; or a combination thereof.

In the embodiments of the invention, the second IMS call establishing module 125 can be implemented and configured by hardware, firmware, software, and any combination thereof. The second IMS call establishing module 125, when executed by the second processor 122 (e.g., via executing program codes stores in second memory device 123), allow the client device 120 to perform embodiments of the present invention.

In an embodiment of the invention, when a network connection (e.g. a Wi-Fi connection) between the electronic device 110 and the client device 120 has been established, the client device 120 may determine whether the electronic device 110 supports IMS service based on a value of a specific field in a packet from the electronic device 110. In an example, when the network connection between the electronic device 110 and the client device 120 has been established, the electronic device 110 may transmit the packet with the specific field to the client device 120. In another example, when the network connection between the electronic device 110 and the client device 120 has been established, the client device 120 may send a query to the electronic device 110 to query the electronic device 110 whether supports IMS service, and then the electronic device 110 may transmit the packet with the specific field to the client device 120.

If the electronic device 110 does not support IMS service but the client device 120 supports IMS service itself, the client device 120 can dial an IMS call (e.g. a voice over NR (VoNR) call or a voice over LTE (VoLTE) call) by itself.

If the electronic device 110 supports IMS service, when the client device 120 wants to dial an IMS call (e.g. a voice over NR (VoNR) call or a voice over LTE (VoLTE) call), the second IMS call establishing module 125 may transmit call information about the IMS call to the first IMS call establishing module 115 via the second communication circuit 121 through the network connection between the electronic device 110 and the client device 120. In an embodiment of the invention, the call information may include a call number associated with the IMS call, but the invention should not be limited thereto.

After the first IMS call establishing module 115 receives the call information of the IMS call via the first communication circuit 111 through the network connection, the first processor 112 may establish the IMS call based on the call information of the IMS call. Specifically, the first processor 112 may use the IMS capability of the electronic device 110 to establish the IMS call connection with a network end (e.g. 4G network or 5G network, but the invention should not be limited thereto) based on the call information of the IMS call.

After the IMS call is established, the first communication circuit 111 may transmit the voice packets associated with the IMS call to the client device 120 through the network connection between the electronic device 110 and the client device 120. According to an embodiment of the invention, after the IMS call is established, the first IMS call establishing module 115 may allocate a dedicated bearer for the voice packets associated with the IMS call to avoid other types of packets (e.g. stream packet, text packet, but the invention should not be limited thereto) associated with other client device connected to the electronic device 110 interfering the IMS call. That is to say, the voice packets associated with the IMS call may have higher priority than other types of packets. In an embodiment, the first IMS call establishing module 115 may set the voice packets associated with the IMS call having higher priority than other types of packets by setting a value of a specific field of the voice packet.

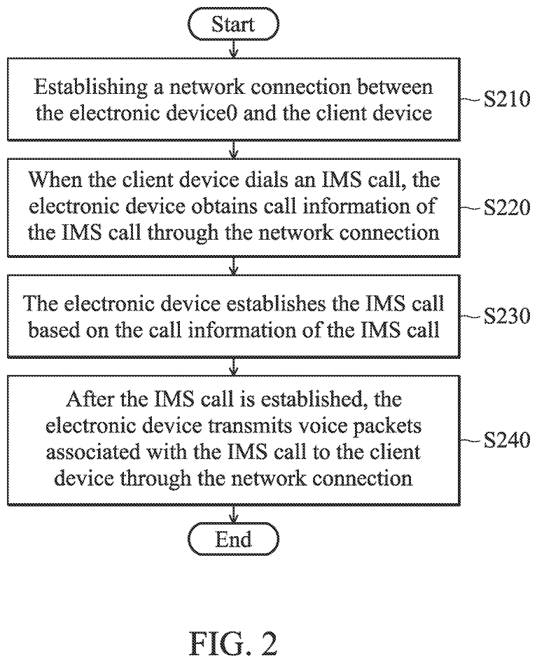

FIG. 2 is a flow chart illustrating an IP Multimedia Subsystem (IMS) call establishing method according to an embodiment of the invention. The IMS call establishing method can be applied to the IMS call establishing system 100 which comprises an electronic device 110 and a client device 120, wherein the electronic device 110 supports IMS service. As shown in FIG. 2, in step S210, a network connection between the electronic device 110 and the client device 120 is established.

In step S220, when the client device 120 dials an IMS call, the electronic device 110 obtains call information of the IMS call through the network connection.

In step S230, the electronic device 110 establishes the IMS call based on the call information of the IMS call.

In step S240, after the IMS call is established, the electronic device 110 transmits voice packets associated with the IMS call to the client device through the network connection.

In some embodiments of the invention, in the IMS call establishing method, the IMS call may be a voice over NR (VoNR) call or a voice over LTE (VoLTE) call.

In some embodiments of the invention, in the IMS call establishing method, the call information may include a call number associated with the IMS call.

In some embodiments of the invention, in the IMS call establishing method, the client device may not have IMS capability.

In some embodiments of the invention, in the IMS call establishing method, the voice packets may have higher priority.

In some embodiments of the invention, in the IMS call establishing method, the client device 120 may know that the electronic device 110 supports the IMS service according to a specific field in a packet from the electronic device 110.

In the IMS call establishing method provided in the invention, when the client device does not support IMS service, the client device still can dial an IMS call through an electronic device which supports IMS service without enabling the IMS service.

Use of ordinal terms such as “first”, “second”, “third”, etc., in the disclosure and claims is for description. It does not by itself connote any order or relationship.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer software product may comprise packaging materials.

It should be noted that although not explicitly specified, one or more steps of the methods described herein can include a step for storing, displaying and/or outputting as required for a particular application. In other words, any data, records, fields, and/or intermediate results discussed in the methods can be stored, displayed, and/or output to another device as required for a particular application. While the foregoing is directed to embodiments of the present invention, other and further embodiments of the invention can be devised without departing from the basic scope thereof. Various embodiments presented herein, or portions thereof, can be combined to create further embodiments. The above description is of the best-contemplated mode of carrying out the invention. This description is made for the purpose of illustrating the general principles of the invention and should not be taken in a limiting sense. The scope of the invention is best determined by reference to the appended claims.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An IP Multimedia Subsystem (IMS) call establishing method, applied to an electronic device which supports IMS service, comprising:
establishing a network connection between the electronic device and a client device;
when the client device dials an IMS call, obtaining call information of the IMS call through the network connection; and
establishing the IMS call based on the call information of the IMS call.

2. The IMS call establishing method of claim 1, wherein the IMS call is a voice over NR (VoNR) call or a voice over LTE (VoLTE) call.

3. The IMS call establishing method of claim 1, wherein the call information includes a call number associated with the IMS call.

4. The IMS call establishing method of claim 1, wherein the client device does not have IMS capability.

5. The IMS call establishing method of claim 1, comprising:
after the IMS call is established, transmitting voice packets associated with the IMS call to the client device through the network connection.

6. The IMS call establishing method of claim 5, wherein the voice packets have higher priority.

7. The IMS call establishing method of claim 1, wherein the client device knows that the electronic device supports the IMS service according to a specific field in a packet from the electronic device.

8. An electronic device for establishing IP Multimedia Subsystem (IMS) calls, comprising:
a Subscriber Identity Module (SIM) card, supporting IMS service;
a communication circuit, configured to establish a network connection between the electronic device and a client device, wherein when the client device dials an IMS call, the communication circuit obtains call information of the IMS call from the client device through the network connection; and
a processor, coupled to the communication circuit and establishing the IMS call based on the call information of the IMS call.

9. The electronic device of claim 8, wherein the IMS call is a voice over NR (VoNR) call or a voice over LTE (VoLTE) call.

10. The electronic device of claim 8, wherein the call information includes a call number associated with the IMS call.

11. The electronic device of claim 8, wherein the client device does not have IMS capability.

12. The electronic device of claim 8, wherein after the IMS call is established, the communication circuit transmits voice packets associated with the IMS call to the client device through the network connection.

13. The electronic device of claim 11, wherein the voice packets have higher priority.

14. A user equipment (UE), comprising:
a communication circuit, configured to establish a network connection between an electronic device which supports IP Multimedia Subsystem (IMS) service and the UE, wherein when the UE dials an IMS call, the communication circuit transmits call information of the IMS call to the electronic device through the network connection; and
a processor, coupled to the communication circuit and after the IMS call is established by the electronic device, processing the IMS call.

15. The UE of claim 14, wherein the IMS call is a voice over NR (VoNR) call or a voice over LTE (VoLTE) call.

16. The UE of claim 14, wherein the call information includes a call number associated with the IMS call.

17. The UE of claim 14, further comprising:
a Subscriber Identity Module (SIM) card, wherein the SIM does not have IMS capability.

18. The UE of claim 14, wherein after the IMS call is established, the communication circuit receives voice packets associated with the IMS call from the electronic device through the network connection.

19. The UE of claim 18, wherein the voice packets have higher priority.

20. The UE of claim 14, wherein the processor knows that the electronic device supports the IMS service according to a specific field in a packet from the electronic device.
